(19) United States
(12) Patent Application Publication
(10) Pub. No.: US 2007/0141449 A1
(43) Pub. Date: Jun. 21, 2007

(54) Secondary battery and pressing member

(76) Inventor: Yong-Sam Kim, Yongin-si (KR)

Correspondence Address: CHRISTIE, PARKER & HALE, LLP, PO BOX 7068, PASADENA, CA, 91109-7068, US

(21) Appl. No.: 11/639,638

(22) Filed: Dec. 15, 2006

(30) Foreign Application Priority Data
Dec. 19, 2005 (KR) 10-2005-0125239

(51) Int. Cl. H01M 2/02; H01M 2/08

(52) U.S. Cl. 429/66; 429/185; 429/164; 29/623.1

(57) ABSTRACT

A secondary battery including an electrode assembly having a positive electrode, a negative electrode, and a separator interposed between the positive electrode and the negative electrode and a casing having an opening for receiving the electrode assembly. The casing houses the electrode assembly and has a clamping portion located at an inner circumference of the casing proximal to the opening. The secondary battery also includes a cap assembly combined with the casing at the clamping portion to seal the casing and a pressing member located between the electrode assembly and the clamping portion, the pressing member having a support portion protruding toward a center of the casing. The support portion applies pressure to and secures the electrode assembly when the clamping portion is inwardly trenched during an externally applied clamping process.

### CROSS-REFERENCE TO RELATED APPLICATION

This application claims priority to and the benefit of Korean Patent Application No. 10-2005-0125239 filed in the Korean Intellectual Property Office on Dec. 19, 2005, the entire content of which is incorporated herein by reference.

### BACKGROUND OF THE INVENTION

1. Field of the Invention

The present invention relates to a secondary battery, and more particularly, to a cylindrical secondary battery having an improved construction.

2. Description of the Related Art

It is known in the art that a secondary battery is rechargeable while a primary battery is not rechargeable.

A low capacity battery obtained by packaging a single battery cell is used as a power supply for portable miniaturized electronic devices such as mobile phones, laptop computers, and camcorders. A large capacity battery obtained by connecting a plurality of battery cells is widely used as a power supply for driving motors of movable electric apparatus such as hybrid electric vehicles (HEV).

A secondary battery may be formed in a variety of shapes such as a cylindrical or a rectangular secondary battery. A conventional cylindrical secondary battery includes an electrode assembly constructed by winding a stack of band shaped positive and negative electrodes and an insulation separator interposed therebetween in a jelly roll shape. A conventional cylindrical secondary battery also includes a casing on which the electrode assembly is stored, and a cap assembly installed in the casing and having an external terminal.

The cap assembly is installed on an opening of the casing to provide a single battery module, and covers the opening of the casing to seal it. In order to provide a seal, a gasket is inserted between the cap assembly and the casing.

Some secondary batteries having the aforementioned construction have a charge collector instead of a tap to reduce electrical resistance in a charge collecting construction. Positive and negative charge collectors may be welded to either end of the electrode assembly, the negative charge collector being welded to the casing, and the positive charge collector being electrically connected to the cap assembly.

However, conventional secondary batteries having the aforementioned construction frequently experience separation between the casing and the negative charge collector welded to the casing when the secondary battery is externally impacted.

### SUMMARY OF THE INVENTION

According to an exemplary embodiment of the present invention, a secondary battery is provided comprising an electrode assembly having a positive electrode, a negative electrode, and a separator interposed between the positive electrode and the negative electrode. The secondary battery also includes a casing having an opening for receiving the electrode assembly, the casing housing the electrode assembly and having a clamping portion located at an inner circumference of the casing proximal to the opening, and a cap assembly combined with the casing at the clamping portion to seal the casing. A pressing member is located between the electrode assembly and the clamping portion, the pressing member having a support portion protruding toward a center of the casing, wherein the support portion applies pressure to and secures the electrode assembly when the clamping portion is inwardly trenched during an externally applied clamping process. A charge collector may be fixed to the electrode assembly and may be in contact with the support portion. The support portion may be substantially parallel to a planar surface of the charge collector.

The pressing member may further include a lower wall insulation portion extending substantially perpendicularly from the support portion and surrounding at least a portion of the electrode assembly and an elastic portion connected to the lower wall insulation portion as an integrated body, the elastic portion protruding toward the clamping portion such that pressure applied to the clamping portion during clamping is transferred to the elastic portion. The support portion may be located between the lower wall insulation portion and the clamping portion. The elastic portion may extend toward the clamping portion at an acute angle relative to the support portion and the elastic portion may have a concave shape. Additionally, the elastic portion may have a plurality of slots.

The secondary battery may further include a gasket located between the cap assembly and the casing, wherein the pressing member is integrated with the gasket as a single body.

In another embodiment of the present invention, a method of preventing separation between an electrode assembly and a casing of a secondary battery due to external impact is provided. The method includes locating a pressing member between the electrode assembly and the clamping portion, the pressing member having a support portion protruding toward a center of the casing, and externally clamping the clamping portion to inwardly trench the clamping portion such that the support portion applies pressure to and secures the electrode assembly. The method may further include locating a lower wall insulation portion of the pressing member between the electrode assembly and the casing, the lower wall insulation portion extending substantially perpendicularly from the support portion, and locating an elastic portion of the pressing member between the clamping portion and the support portion, the elastic portion connected to the lower wall insulation portion as an integrated body.

### BRIEF DESCRIPTION OF THE DRAWINGS

FIG. 1 is a cross-sectional view illustrating a secondary battery according to an embodiment of the present invention.

FIG. 2 is an exploded perspective view illustrating a pressing member and an electrode assembly of the secondary battery shown in FIG. 1.

FIG. 3 is a schematic cross-sectional view illustrating the pressing member shown in FIG. 2.

FIG. 4 is a partial cross-sectional view illustrating a process of clamping a secondary battery according to an embodiment of the present invention.

FIG. 5 is a schematic cross-sectional view illustrating a pressing member according to another embodiment of the present invention.

FIG. 6 is a cross-sectional view illustrating a secondary battery according to yet another embodiment of the present invention.

FIG. 7 is an exploded perspective view illustrating a pressing member and a battery assembly of the secondary battery of FIG. 6.

FIG. 8 is an exploded perspective view illustrating a pressing member and a battery assembly according to still another embodiment of the present invention.

### DETAILED DESCRIPTION

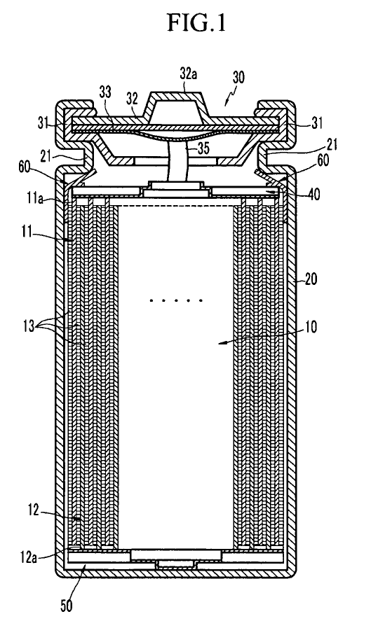

Referring to FIG. 1, a secondary battery includes: an electrode assembly 10 having positive and negative electrodes 11, 12 and a separator 13 interposed therebetween and a casing 20 to store electrolyte and house the electrode assembly 10, the casing having an opening on one side end. The secondary battery also includes a cap assembly 30 coupled to the casing 20 to seal the opening of the casing; a positive charge collector 40 electrically connected to the positive electrode 11 of the electrode assembly 10; and a negative charge collector 50 electrically connected to the negative electrode 12 of the electrode assembly.

The casing 20 may be formed of conductive metal such as aluminum, aluminum alloy, or steel plated with nickel and may have a cylindrical shape having an inner space for storing the electrode assembly 10.

Although a cylindrical secondary battery will be described by this exemplary embodiment, the invention is not limited thereto, and various shapes such as a rectangular secondary battery may be adopted.

The electrode assembly 10 may have a stack structure including positive and negative electrodes 11, 12 obtained by coating a respective activation material on a charge collector and a separator 13 interposed therebetween, or may have a jelly roll shape obtained by winding a stack of the positive electrode 11, the separator 13, and the negative electrode 12. FIG. 1 illustrates a cylindrical jelly roll-type construction electrode assembly 10 stored in the cylindrical casing 20.

The electrode assembly 10 has positive and negative charge collectors 40, 50 connected to the positive and negative electrodes 11, 12, respectively. One end of the positive electrode 11 having an uncoated portion 11a absent positive activation material is attached to the positive charge collector 40 and one end of the negative electrode 12 having an uncoated portion 12a absent the negative activation material is attached to the negative charge collector 50.

The cap assembly 30 includes a cap plate 32 having an external terminal 32a and a gasket 31 for providing insulation between the casing 20 and the cap plate 32. The cap assembly 30 may further include a vent plate 33 which is fracturable at a predetermined pressure to ventilate gas in order to prevent explosion of the battery. The vent plate 33 is electrically connected with the positive charge collector 40 through a lead 35.

The vent plate 33 is not limited to the specific shape or dimensions shown in the drawings, but rather may be embodied in various shapes and sizes as long as it can serve to cut off electrical connection between the electrode assembly and the external terminal 32a through the lead 35 at a predetermined pressure.

The cap assembly 30 is combined with the casing 20 with the gasket 31 being interposed therebetween using an externally applied clamping process to seal the casing 20. In the clamping process, a clamping portion 21 is inwardly trenched around a circumference of the upper portion of the casing 20 as shown in FIG. 1.

In this case, a pressing member 60 is provided between the clamping portion 21 and the positive charge collector 40. During a pressing process, pressure applied to the pressing member 60 by the clamping portion 21 elastically presses the positive charge collector 40 of the electrode assembly 10 downward.

The pressing member 60 may be formed from an elastic insulation material such as plastic, but the material of the pressing member 60 is not limited thereto.

The pressing member 60 according to the present embodiment is installed to surround the circumference of the positive charge collector 40 of the electrode assembly 10 so as to insulate the casing 20 from the positive charge collector 40. In addition, the pressing member 60 also extends under the positive charge collector 40 to separate the electrode assembly 10 from the casing 20. Since the pressing member 60 separates the electrode assembly 10 from the inner surface of the casing 20, a separate insulation layer between the casing 20 and the electrode assembly 10 is not necessary.

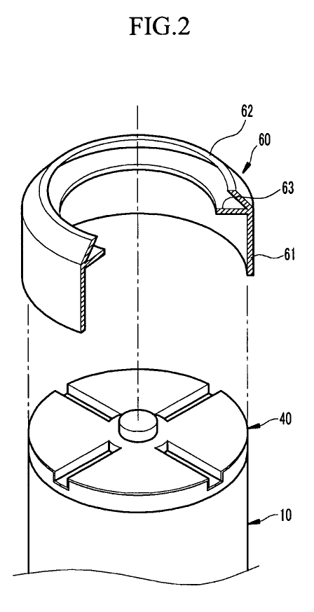

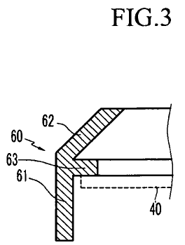

Referring to FIGS. 2 and 3, a lower wall insulation portion 61 of the pressing member 60 surrounds the side surface of the positive charge collector 40 to function as an insulation plate. The lower wall insulation portion 61 extends from the cap plate 31 around the circumference of the electrode assembly 10 by a predetermined length so as to provide an insulation portion.

An upper end elastic portion 62 of the pressing member 60 extends above the positive charge collector 40 and contacts the clamping portion 21. The elastic portion 62 will be elastically pressed against the positive charge collector 40 when pressure is applied to the clamping portion 21 during the clamping process.

A support portion 63 protrudes toward the center of the secondary battery and is located between the lower wall insulation portion 61 and the elastic portion 62. The support portion 63 is formed to contact a top planar surface of the positive charge collector 40.

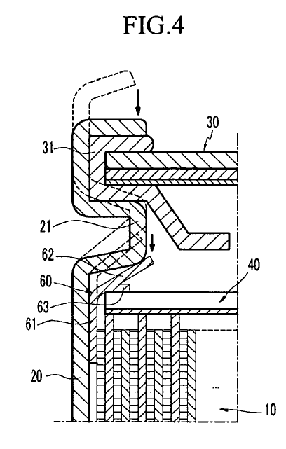

As shown in FIG. 4, pressure is applied to the cap assembly 30 to move the clamping portion 21 toward the electrode assembly 10 by a clamping process. Accordingly, when pressure is applied to the elastic portion 62, the support portion 63 makes close contact with the positive charge collector 40.

Therefore, the secondary battery is assembled such that the pressing member 60 applies a predetermined pressure to the electrode assembly 10. Additionally, the negative charge collector 50 disposed in a lower portion of the electrode assembly 10 makes close contact with the bottom of the casing 20 due to the pressure applied by the pressing member 60.

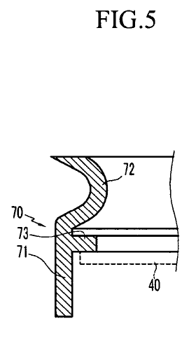

FIG. 5 illustrates a pressing member 70 according to another embodiment of the present invention which may be used with a secondary battery substantially similar to the secondary battery described above. A lower wall insulation portion 71 of the pressing member 70 surrounds a circumference of the positive charge collector 40 to function as an insulation plate and extends along the electrode assembly 10 by a predetermined length to provide insulation.

An elastic portion 72 located adjacent the lower wall insulation portion 71 has a concave cross-section such that one end is disposed in a lower portion of the clamping portion. Additionally, a support portion 73 disposed between the lower wall insulation portion 71 and the elastic portion 72 protrudes toward a center of the secondary battery and makes close contact with the positive charge collector 40 during the clamping process.

In this embodiment, the clamping portion presses the concave elastic portion 72 during the clamping process. Accordingly, the insulation portion 71 connected to the elastic portion 72 applies pressure to the positive charge collector 40 forcing the electrode assembly 10 to be pressed toward the bottom of the casing.

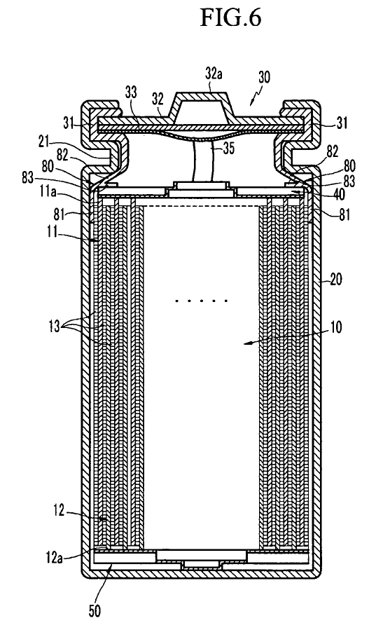

FIG. 6 illustrates a secondary battery according to yet another embodiment of the present invention, the secondary battery having a construction substantially similar to the secondary battery described above.

Referring to FIG. 6, a gasket 31 includes a pressing member 80 integrated as a single body, the pressing member extending toward a lower end of the secondary battery so as to make contact with the positive charge collector. Similarly to the previously described embodiments, the pressing member portion 80 is pressed by the clamping portion 21 during the clamping process and elastically presses the positive charger collector 40 of the electrode assembly 10.

The pressing member 80 has a lower wall insulation portion 81 which surrounds the side surface of the positive charge collector 40 and extends toward the electrode assembly 10 to provide insulation. An elastic portion 82 connected with the lower wall insulation portion 81 extends from the positive charge collector 40 toward a bottom of the clamping portion 21 and is connected with a lower end of the gasket 31 so as to form an integrated single body.

In addition, a support portion 83 is provided between the lower wall insulation portion 81 and the elastic portion 82. The support portion 83 is protrudes toward the center of the secondary battery and makes close contact with a top surface of the positive charge collector 40 to press the positive charge collector 40.

In this embodiment, the lower end of the gasket 31 and the upper end of the elastic portion 82 extend sufficiently toward the center of the casing 20 so as to not interfere with the clamping portion 21 which is pressed toward the center of the battery during the clamping process.

According to the aforementioned construction, during the clamping process, pressure is applied to the elastic portion 82, and the support portion 83 causes the positive charge collector 40 and the electrode assembly 10 to be pressed toward the bottom of the casing 20. As such, the negative charge collector 50 can be secured within the casing.

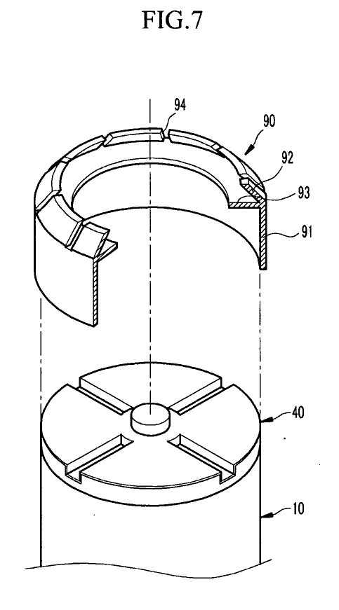

Referring to FIG. 7, a lower wall insulation portion 91 of a pressing member 90 according to still another embodiment of the present invention surrounds the side surface of the positive charge collector 40 and extends toward the electrode assembly 10 so as to provide an insulation portion.

An elastic portion 92 extends upward from the lower wall insulation portion 91 toward the clamping portion. According to this exemplary embodiment, the elastic portion 92 is slanted toward a center of the secondary battery and has a plurality of slots 94 so that the elastic portion 92 bends easily when pressure is applied by the clamping portion to the elastic portion 92. The number of slots 94 is not limited by the exemplary embodiment.

A support portion 93 protrudes toward a center of the secondary battery and is located between the lower wall insulation portion 91 and the elastic portion 92. The support portion 93 makes close contact with the positive charge collector 40 to apply pressure to the positive charge collector 40.

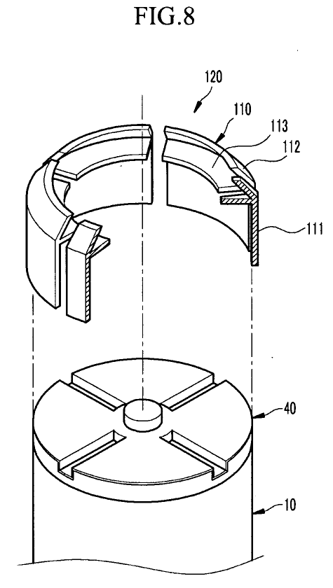

Referring to FIG. 8, a pressing member 120 according to yet another exemplary embodiment of the present invention is constructed of a plurality of unit pressing members 110.

The unit pressing members 110 are arranged circumferentially around the electrode assembly to constitute a single pressing member 120 which surrounds the circumference of the electrode assembly. Accordingly, the pressing member 120 separates the electrode assembly from the casing to electrically insulate the electrode assembly from the casing.

A lower wall insulation portion 111 of each unit pressing member 110 covers the side surface of the positive charge collector 40 and extends toward the electrode assembly 10 to provide an insulation portion. An elastic portion 112 extends centrally toward the cap plate from the lower wall insulation portion 111 to the clamping portion.

A support portion 113 is located between the lower wall insulation portion 111 and the elastic portion 112, the support portion 113 protruding toward the center of the secondary battery and making close contact with the positive charge collector 40 to be able to apply pressure to the positive charge collector 40.

According to this exemplary embodiment, since the pressing member 120 is divided into a plurality of unit pressing members 110, it is possible to conveniently install and bend the pressing member 120 during the clamping process.

According to the aforementioned exemplary embodiments of the present invention, it is possible to minimize movement of the electrode assembly inside the casing. Also, it is possible to prevent the negative charge collector welded to the casing from being separated from the casing due to external impact. In addition, it is possible to improve reliability of the battery and increase the battery's lifetime.

Although exemplary embodiments of the present invention have been described, the present invention is not limited to the embodiments, and may be modified in various forms without departing from the scope of the appended claims, the detailed description, and the accompanying drawings of the present invention.

What is claimed is:

1. A secondary battery comprising:
an electrode assembly having a positive electrode, a negative electrode, and a separator interposed between the positive electrode and the negative electrode;
a casing having an opening for receiving the electrode assembly, the casing housing the electrode assembly and having a clamping portion located at an inner circumference of the casing proximal to the opening;
a cap assembly combined with the casing at the clamping portion to seal the casing; and
a pressing member located between the electrode assembly and the clamping portion, the pressing member having a support portion protruding toward a center of the casing,
wherein the support portion applies pressure to and secures the electrode assembly when the clamping portion is inwardly trenched during an externally applied clamping process.

2. The secondary battery of claim 1,
wherein a charge collector is fixed to the electrode assembly; and
wherein the support portion contacts the charge collector.

3. The secondary battery of claim 2, wherein the support portion is substantially parallel to a planar surface of the charge collector.

4. The secondary battery of claim 2, wherein the pressing member further comprises:
a lower wall insulation portion extending substantially perpendicularly from the support portion and surrounding at least a portion of the electrode assembly; and
an elastic portion connected to the lower wall insulation portion as an integrated body, the elastic portion protruding toward the clamping portion such that pressure applied to the clamping portion during clamping is transferred to the elastic portion.

5. The secondary battery of claim 4, wherein the support portion is located between the lower wall insulation portion and the clamping portion.

6. The secondary battery of claim 4, wherein the elastic portion extends toward the clamping portion at an acute angle relative to the support portion.

7. The secondary battery of claim 4, wherein the elastic portion has a concave shape.

8. The secondary battery of claim 4, wherein the elastic portion has a plurality of slots.

9. The secondary battery of claim 4, wherein the lower wall insulation portion surrounds a circumference of the charge collector and extends between the electrode assembly and the casing.

10. The secondary battery of claim 1, wherein the pressing member is an elastic material.

11. The secondary battery of claim 1, further comprising a gasket located between the cap assembly and the casing, wherein the pressing member is integrated with the gasket as a single body.

12. The secondary battery of claim 1, wherein the pressing member comprises a plurality of unit pressing members arranged around a circumference of the electrode assembly.

13. The secondary battery of claim 1, wherein the secondary battery is cylindrical.

14. A pressing member for applying pressure to and securing a charge collector installed on an electrode assembly of a secondary battery, the secondary battery including a casing having an opening for receiving the electrode assembly, the casing housing the electrode assembly and having a clamping portion located at an inner circumference of the casing proximal to the opening, and a cap assembly combined with the casing at the clamping portion to seal the casing, the pressing member comprising:
an elastic portion locatable between the clamping portion and the charge collector such that the clamping portion contacts and exerts pressure on the elastic portion when the clamping portion is inwardly trenched during an externally applied clamping process;
a lower wall insulation portion connected to the elastic portion and locateable between the electrode assembly and the casing; and
a support portion located between the lower wall insulation portion and the elastic portion such that the support portion makes contact with and secures the charge collector when the clamping portion is inwardly trenched during a clamping process.

15. The pressing member of claim 14, wherein the elastic portion extends toward the clamping portion at an acute angle relative to the support portion.

16. The pressing member of claim 14, wherein the elastic portion includes at least one slot.

17. A method of preventing separation between an electrode assembly and a casing of a secondary battery due to external impact, the secondary battery including an electrode assembly having a positive electrode, a negative electrode, and a separator interposed between the positive electrode and the negative electrode, a casing having an opening for receiving the electrode assembly, the casing housing the electrode assembly and having a clamping portion located at an inner circumference of the casing proximal to the opening, and a cap assembly combined with the casing at the clamping portion to seal the casing, the method comprising:
locating a pressing member between the electrode assembly and the clamping portion, the pressing member having a support portion protruding toward a center of the casing; and
externally clamping the clamping portion to inwardly trench the clamping portion such that the support portion applies pressure to and secures the electrode assembly.

18. The method of claim 17, further comprising:
locating a lower wall insulation portion of the pressing member between the electrode assembly and the casing, the lower wall insulation portion extending substantially perpendicularly from the support portion; and
locating an elastic portion of the pressing member between the clamping portion and the support portion, the elastic portion connected to the lower wall insulation portion as an integrated body.
